(19) United States
(12) Patent Application Publication
(10) Pub. No.: US 2006/0053032 A1
(43) Pub. Date: Mar. 9, 2006

(54) Method and apparatus for reporting national and sub-national longitudinal prescription data

(76) Inventors: Blake R Weiler, Malvern, PA (US); Jill Tolle, Collegeville, PA (US)

Correspondence Address: BAKER & BOTTS, 30 ROCKEFELLER PLAZA, NEW YORK, NY, 10112, US

(21) Appl. No.: 10/517,272

(22) PCT Filed: Jun. 13, 2003
(86) PCT No.: PCT/US03/18886

§ 371 Date: Sep. 21, 2005

Related U.S. Application Data
(60) Provisional application No. 60/388,453, filed on Jun. 13, 2002.

(51) Int. Cl. G06Q 10/00

(52) U.S. Cl. 705/2

(57) ABSTRACT

A method and logic arrangement for analyzing prescription data is provided. The method includes receiving an indication of a selected report type, accessing at least one of product oriented longitudinal data (202), patient oriented longitudinal data (204) and prescriber oriented longitudinal data (206) based at least in part on the selected report type, analyzing the at least one of product oriented longitudinal data (202), patient oriented longitudinal data (204) and prescriber oriented longitudinal data (206), and formatting a report of the selected report type including the at least one of product oriented longitudinal data (202), patient oriented longitudinal data (204) and prescriber oriented longitudinal data (206).

### RELATED APPLICATIONS

This application claims priority to U.S. Provisional Application Ser. No. 60/388,453 filed Jun. 13, 2002, which is incorporated by reference herein in its entirety.

### BACKGROUND OF THE INVENTION

1. Field of the Invention

The present invention relates to systems and methods for interpreting and analyzing data and, more particularly to a system and method for interpreting and analyzing prescription data at the national and sub-national level to inform pharmaceutical marketers about market trends.

2. Background Art

Manufacturers and distributors of retail, wholesale and mail-order products generally monitor product sales in order to maintain proper inventory and to be able to direct marketing efforts. Monitoring may be accomplished by documenting sales at wholesale distributors, retail outlets and mail-order facilities and transferring this sales data to a central point for evaluation. Sales data is valuable as a business intelligence tool to regularly inform sales professionals about the state of the marketplace.

In particular, each day throughout the pharmaceutical and healthcare industries millions of products are prescribed and sold worldwide. Prescriptions are written by doctors and filled at pharmacies; medical devices are sold at doctors offices, hospitals and pharmacies. Individual businesses participating in various aspects of the pharmaceutical and healthcare industries create data pertaining to the goods sold to conform with governmental regulations, to aid in inventory tracking; and to track market share possessed by branded and generic manufacturers.

Accordingly, there exists a need for a system and method to track this information over time, store it in a centralized database, to extract crucial information from the raw information contained in a centralized data repository containing industry data and to produce a report which allows an individual sales person to develop a coherent understanding of the raw information.

### SUMMARY OF THE INVENTION

An object of the present invention is to provide system and method for extracting crucial information from raw information related to prescription data.

It is also an object of the present invention to provide a system, method and logic arrangement that supplies information concerning national and sub-national level prescription activity to requests sent over a communication network.

Still another object of the present invention is to provide a system and method that supplies reports concerning national and sub-national level prescription activity to customers.

These and other objects can be achieved with the exemplary embodiment of the method and logic arrangement according to the present invention, in which a method for analyzing prescription data is provided. The method includes receiving an indication of a selected report type, accessing at least one of product oriented longitudinal data, patient oriented longitudinal data and prescriber oriented longitudinal data based at least in part on the selected report type, analyzing the at least one of product oriented longitudinal data, patient oriented longitudinal data and prescriber oriented longitudinal data, and formatting a report of the selected report type including the at least one of product oriented longitudinal data, patient oriented longitudinal data and prescriber oriented longitudinal data.

In another advantageous embodiment of the present invention, a method and logic arrangement for reporting prescription data is provided. The method includes accessing product oriented longitudinal data, patient oriented longitudinal data and prescriber oriented longitudinal data, analyzing the product oriented longitudinal data, the patient oriented longitudinal data and the prescriber oriented longitudinal data, and formatting at least one report, each of the at least one report utilizing one of product oriented longitudinal data, patient oriented longitudinal data and prescriber oriented longitudinal data.

### BRIEF DESCRIPTION OF THE DRAWINGS

For a more complete understanding of the present invention and its advantages, reference is now made to the following description, taken in conjunction with the accompanying drawings, in which:

FIG. 1 shows a first exemplary embodiment of a market dynamics system according to the present invention;

FIG. 2 shows a logical view of the data of longitudinal prescription market dynamics database of FIG. 1;

FIG. 3 shows an exemplary product outlook report according to the present invention;

FIG. 4 shows an exemplary prescriber outlook report according to the present invention; and

FIG. 5 shows an exemplary embodiment of a flow chart for calculating a confidence interval according to the present invention.

Throughout the drawings, the same reference numerals and characters, unless otherwise stated, are used to denote like features, elements, components, or portions of the illustrated embodiments. Moreover, while the present invention will now be described in detail with reference to the Figures, it is done so in connection with the illustrative embodiments.

### DETAILED DESCRIPTION OF THE PREFERRED EMBODIMENTS

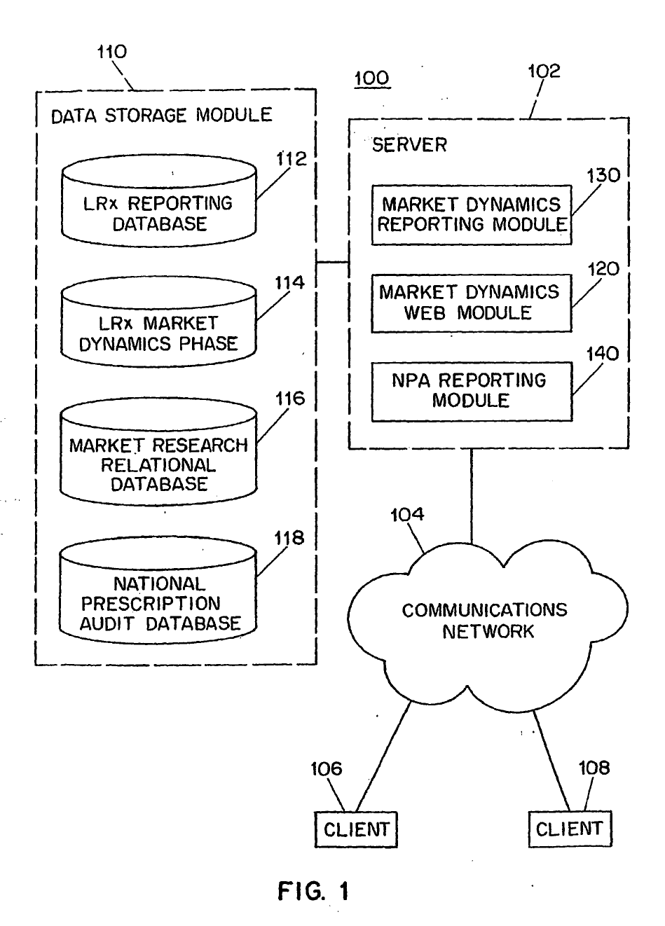

FIGS. 1-5 illustrate various embodiments of a system and method for managing and interpreting prescription data. Generally, the exemplary system and method create reports to inform pharmaceutical marketing professionals concerning global, national and sub-national market information.

FIG. 1 illustrates a market dynamics system 100. The market dynamics system 100 is a patient-level, longitudinal data solution that provides pharmaceutical marketers with global, national and sub-national market information across several outlooks. The term “longitudinal” refers to data collected over a particular period of time where a patient can be tracked. Preferrably, the identity of the patient is not known. The outlooks presented to the marketers include product outlook, patient outlook and prescriber outlook. This information allows the marketers to better understand market specific, competitive landscape and brand performance for switching and continued therapy analyses, patient therapy progression, and prescriber initial and subsequent treatment behavior over time. The market dynamics system 100 utilizes information stored in a data storage module 110 to deliver new market insight to pharmaceutical marketers utilizing three information delivery modules: a market dynamics web module 120, a market dynamics reporting module 130, and a national prescription audit reporting module 140. The market dynamics system 100 allows marketers to acquire knowledge in a consistent, reliable and timely manner, where previously such data was only attainable through primary market research.

The market dynamics system 100 includes a server 102, the data storage module 110, a communications network 104, a client 106 and a client 108. The market dynamics web module 120, the market dynamics reporting module 130, and the national prescription audit reporting module 140 are executed on the server 102. Each of the market dynamics web module 120, the market dynamics reporting module 130, and the national prescription audit reporting module 140 may be realized as software programs. The server 102 is in communication with the data storage module 110 and the communications network 104, which is in turn in communication with the clients 106, 108. The data storage module 110 includes several databases upon which the market dynamics system 100 operates. The databases stored by the data storage module 110 include a longitudinal prescription (“LRx”) reporting database 112, a LRx market dynamics database 114, a market research relational database 116, and a national prescription audit database 118.

In a preferred embodiment, the server 102, the data storage module 110, the communications network 104, the client 106 and the client 108 communicate using wireless technology. In another preferred embodiment, the communications network 104 is the internet. In still another preferred embodiment, the communications network 104 is a secure, private network.

The market dynamics web module 120, the market dynamics reporting module 130, and the national prescription audit module 140 provide users of the market dynamics system 100 with information through three delivery methodologies: web delivery, structured reporting and interpretive data reporting. The market dynamics system 100 includes interpretive data/information in conjunction with other delivery mechanisms to allow users an additional insight into a market based upon market dynamics data.

The LRx market dynamics database 114 includes structured data content upon which the market dynamics system 100 relies. The market dynamics reporting module 130, the market dynamics web module 120, and national prescription audit module 140 include applications and products that are used to deliver the information derived from the LRx market dynamics database 114, the national prescription audit database 118, along with the other databases stored on the data storage module 110.

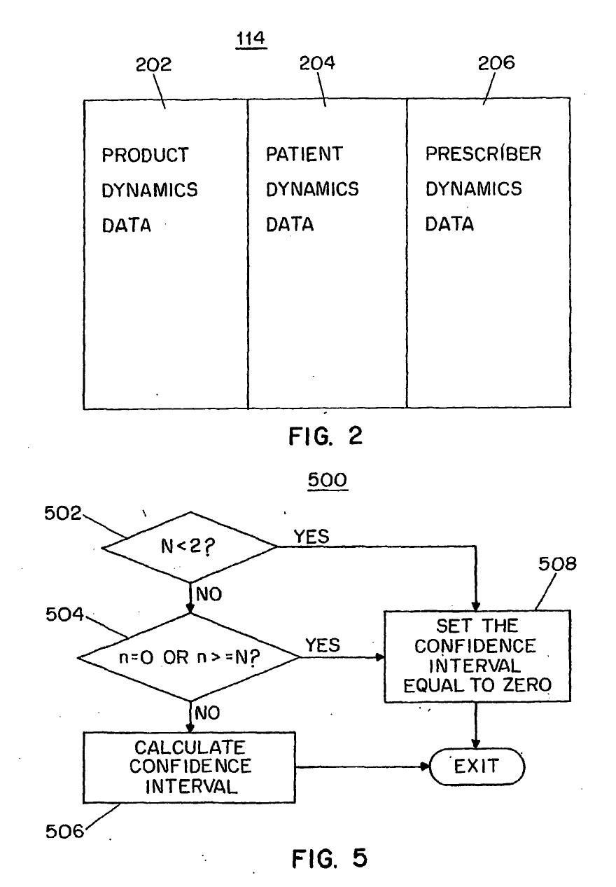

The LRx market dynamics database 114 includes three primary market outlooks that represent core views of longitudinally maintained prescriptions. Within each market outlook, respective subject areas are represented. FIG. 2 illustrates a logical view of the LRx market dynamics database 114. The LRx market dynamics database 114 includes product dynamics data 202, patient dynamics data 204 and prescriber dynamics data 206. The LRx market dynamics database 114 includes various core data elements. The core data elements include source of business, treatment patterns, utilization patterns, and key business metrics.

The LRx market dynamics database 114 contains at least twelve months of data. Source data is accumulated on an on-going basis until six years of history is available. Due to the nature of longitudinal data and its dependencies on suppliers and market definitions, historical values should not be maintained within newly generated datasets. As such, data values produced by the aforementioned processes may return different values based upon slight changes in a request definition as well as changes in supplier status. Data sources used by the LRx market dynamics database 114 include the LRx reporting database, LRx base data, product databases, prescriber databases, specialty databases, the National Prescription Audit database 118, and the market research relational database 116. The National Prescription Audit database 118 includes a National Prescription Audit monthly by specialty database, a National Prescription Audit weekly by specialty database, a National Prescription Audit regional monthly by specialty database, and a National Prescription Audit regional weekly by specialty database.

The source of business core data element is available for all market outlooks: product dynamics data 202, patient dynamics data 204, and prescriber dynamics data 206. This information reports the type of new prescription. Three types of new prescriptions are reported: new prescriptions due to new therapy starts, new prescriptions due to continued therapy and new prescriptions due to refill prescriptions.

The treatment patterns core data element is available for all market outlooks: product dynamics data 202, patient dynamics data 204, and prescriber dynamics data 206. Treatment patterns represent the product titration for patients dosing, titration, and different therapy regimens. For physicians, treatment patterns show who initiates a given prescription, the specialty group, the typical starting dose for a physician or group, and the physician or physician group's titration behavior, i.e. single-agent therapy versus multiple-agent therapy.

The utilization patterns core data element is only available in patient dynamics data 204 and prescriber dynamics data 206. Utilization patterns represent patient compliance and persistence on a drug regimen along with length of therapy. For prescribers, this data focuses on the prescriber's patient population as a whole for compliance and persistence creating indexes for physicians and physician groups.

The key business metrics core data element is available for all market outlooks: product dynamics data 202, patient dynamics data 204, and prescriber dynamics data 206. The key business metrics include ratio, indexes, and retention rates. For example, a particular ratio that may be analyzed concerns the available patient capture rate, measured in prescription counts, along with the retention rate, which is the rate of prescriptions written for patients who had the opportunity to switch but did not switch.

Product dynamics data 202 uses the product as an entry point or view point. This market outlook focuses on quantifying what makes up the product's prescription volume and share. Specifically, quantifying the movement of new prescriptions coming from new patients on the product, new prescriptions coming from patients coming from another product and prescriptions generated from continued course of product/drug therapy. In addition, the drug's titration can be followed and measured by quantifying the change in drug strength over time.

The product dynamics data 202 includes approximately three core data elements. A measurement of any of the core data elements typically reflects prescription counts. The core data elements include source of business, treatment patterns, and key business metrics. The source of business core data element includes data relating to new therapy starts, continued new prescriptions (“NRxs”), continued refill prescriptions (“RRxs”), switched to indications, switched from indications, and the cost of a new prescription. The treatment patterns core data element includes data relating to product titration and product detail concerning switching to or from the product. And the key business metrics core data element includes data relating to the product's retention rate and available capture rate.

The primary dimensions of the core data elements include medical specialty, monthly and weekly, payment type, product group and region. Region types define the summary levels for the product dynamics module 110. All dimensions will be available by the following regional breakouts: national, state and metropolitan statistical area (“MSA”). Medical specialty corresponds to prescriber universe medical specialties translated using the National Prescription Audit medical specialties database. Age corresponds to a patient/physician's year of birth to allow for application specific age calculation. Gender corresponds to male and female breakouts for values. Monthly and weekly includes values that are reported at monthly and weekly time intervals. Payment type corresponds to payment via cash, Medicaid or third party. Payment type values will be based upon LRx method of payment allocations. Product group represents the group of products to which the product belongs. Region refers to data summaries at the National, State and MSA levels. Physician attributes will be defined by information available in the physician universe database.

The processes that take advantage of the product dynamics data 202 will focus on quantifying what makes up a particular drug's or family of drugs' prescription volume and market share. The modules 120, 130, 140 can quantify the movement of prescriptions coming from new prescriptions from new patients on the drug, those prescriptions transferring from another product, and prescriptions generated from continued course of drug therapy. In addition, the drug's titration can be followed and measured by quantifying the change in drug strength over time.

Patient dynamics data 204 uses the patient as the entry point. This market outlook focuses on quantifying the number of patients who have started a new drug therapy, those who have continued therapy, those who have switched to a particular drug and those who have discontinued therapy. In addition, patient treatment patterns are described as well as patient drug utilization patterns along with metrics surrounding length of therapy, compliance and persistence.

The patient dynamics data 204 includes approximately four core data elements. A measurement of any of the core data elements typically reflects patient counts. The core data elements include source of business, treatment patterns, utilization patterns and key business metrics. The source of business core data element includes data relating to new therapy start patients, continued NRx patients, continued RRx patients, patients switched to indications, patients switched from indications, and the value of a new patient. The treatment patterns core data element includes data relating to titration patterns, dosing patterns and therapy regimens. The utilization patterns core data element includes data relating to length of therapy, persistence, compliance and discontinued/lapsed therapy. And the key business metrics core data element includes data relating to new patient count, total patient count, total exposed patient count, and total lifetime exposed patient count. The therapy regimens include mono-therapies, combo-therapies, and add-on therapies.

The primary dimensions of the core data elements include medical specialty, age, gender, monthly and weekly, payment type, product group and region.

Region types define the summary levels for the patient dynamics module 120. All dimensions will be available by the following regional breakouts: national, state and MSA.

Prescriber dynamics data 206 uses the prescriber at the entry point. This is the physician view of longitudinal prescription information across multiple vectors: source of business, treatment patterns, utilization patterns, and specific metrics. This market outlook focuses on various metrics for measuring the specific behavior of the prescriber. This data can be used to calculate the current value of a physician or physician group. Treatment patterns and utilization patterns by physician or physician group are also reported including initial starting doses by physician group, what specialty initiates care versus what specialty changes treatment care. The data also reflects compliance and persistence ratios of different physicians or physician groups.

The prescriber dynamics data 206 includes approximately four core data elements. A measurement of any of the core data elements typically reflects patient counts. The core data elements include source of business, treatment patterns, utilization patterns and key business metrics. The source of business core data element includes data relating to new therapy start patients, continued NRx patients, continued RRx patients, patients switched to indications, patients switched from indications, and the current value of a physician. The treatment patterns core data element includes data initiating and change of care, initial therapy performance, usual starting dose, and titration behavior. The utilization patterns core data element includes data relating to physician compliance expressed as an index or a ratio and physician persistence expressed by a rating. Finally, the key business metrics core data element includes data relating to physician/patient compliance expressed as an index or a ratio and physician/patient persistence expressed as a rating.

The primary dimensions of the core data elements include medical specialty, age, gender, monthly and weekly, payment type, product group, region and physician. Region types define the summary levels for the prescriber dynamics module 130. All dimensions will be available by the following regional breakouts: national, state and MSA. Physician and physician group define fourth and fifth summary levels for the prescriber dynamics module 130. All dimensions, excluding region, will be available by individual physician. Physician and physician group samples will be client defined by various criteria.

Three primary mechanisms are used for delivery of market dynamics system 100 content: market dynamics web module 120, marketing reporting module 130, and the national prescription audit reporting module 140.

The market dynamics web module 120 will include three different solution suites focusing on core metric subject areas: source of business, treatment patterns and utilization patterns. Each solution suite contains individual web applications that a user can select using the client computer 106, 108 depending on particular business events. This approach will allow customers to thoroughly analyze the different aspects of a market via a robust series of metrics based upon prescription counts, patient counts and prescriber view. The solution suites will produce several structured web-based reports as well as interpretive, unstructured data based upon the information contained within the data storage module 110.

The market dynamics web module, 120 allows users to gain structured data access to a web-based reporting capability which utilizes the databases as stored in a centralized repository, here the data storage module 110. Key features of the structured data access are, where applicable: data access limited to customer specific information within the market dynamics database, data access is through syndicated reports to reduce the users need to understand the complexities of the longitudinal data, syndicated drill-through capability supporting limited heuristic data interrogations, limited ad-hoc query capabilities will be provided to allow users to develop their own custom reports and/or metrics, and structured data access will include both production and specialty produced market views of the market data contained within the data storage module 110. The syndicated drill-through capability allows users to access various predefined views of patient, product and provider modules contianed within a report.

The market dynamics web module 120 also allows users to gain unstructured data access to interpretive data/information. Interpretive data/information is a set of work products that provide additional insight into a market based upon market dynamics data. Typically, interpretive data/information will be created and provided by outside sources, for example consultants. The market dynamics web module 120 will allow for outside data generators to publish interpretive data/information in a manner such that it is dynamically accessible by a user through the same interface in which structured data access occurs. As with structured data access, access is limited to customer specific information/content.

In a certain embodiment, the outside data generator is a consultant. In another certain embodiment, the outside data generators are IMS Health, Inc. consultants.

The market dynamics reporting module 130 produces a syndicated report that is distributed to customers through an electronic data delivery mechanism, for example electronic mail, dedicated downloads, bulletin boards or file transfer protocol sessions. The market dynamics reporting module 130 affords users an alternate delivery method for the information contained in the market dynamics database. As with the market dynamics web module 120, the market dynamics reporting module 130 affords users with access to both structured and unstructured data.

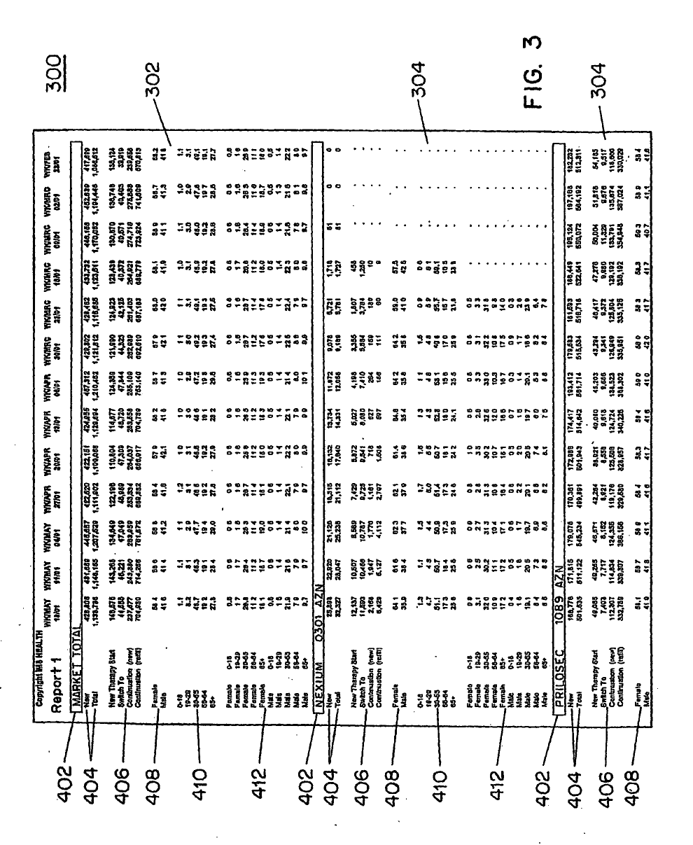

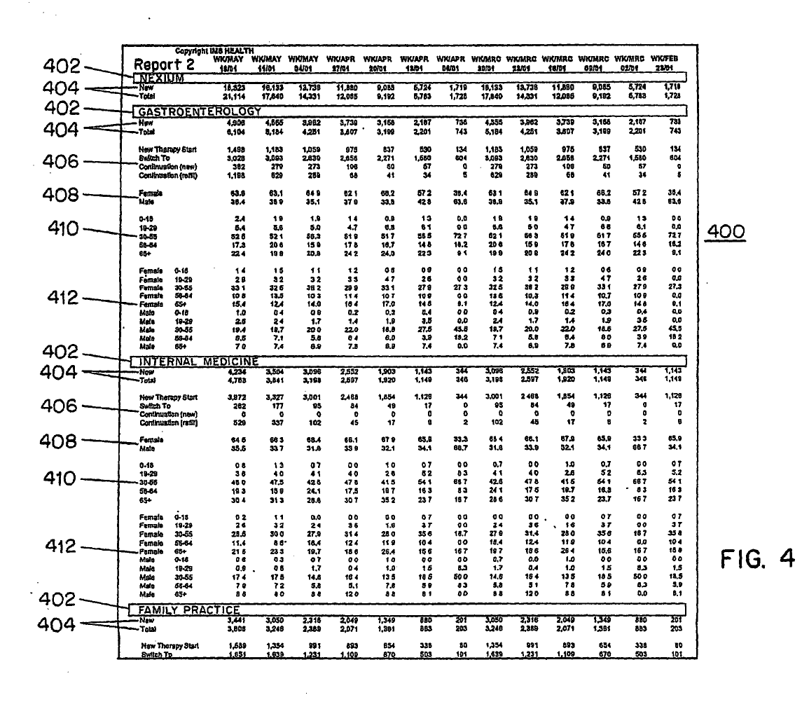

The national prescription audit reporting module 140 creates a short-term integrated longitudinal national prescription audit (“NPA”) client deliverable. The module 140 produces two reports, each containing thirteen data-weeks of NPA projected new and total prescription volume plus various allocations of the NPA prescription volume based on LRx attributes. One report is a product outlook report 300 and the second report is a prescriber outlook report 400. The product outlook report 300 focuses on individual products and product groups. The prescriber outlook report 400 focuses particularly on product group by prescriber specialty level. Both reports 300, 400 are sent to a customer/user in spreadsheet format having two work sheets. Additional worksheets may be added to the report to convey additional information. FIG. 3 shows an exemplary product outlook report 300; FIG. 4 shows an exemplary prescriber outlook report 400.

In a preferred embodiment, the spreadsheet format is Microsoft® Excel® and Lotus® 1-2-3®.

The national prescription audit reporting module 140 utilizes both trackable and non-trackable categorized LRx data. The reports 300, 400 generated by the module 140 are comma-delimited files containing NPA retail prescription volume characterized by LRx category attributes found in the data storage module 110, particularly LRx market dynamics database 114 and the NPA database 118. The NPA database 118 contains weekly data on product groups organized by NPA group specialty level. The data represented in the NPA database 118 includes data from chain, independent, and food store channels. Once the reports 300, 400 are generated, the module 140 must manage certain data files. Particular data files must be deleted or marked as used after use. These data files include LRx records reflecting therapy switches and LRx records having a dispensed date outside the thirteen-week data range ending with the census date of the report.

In creating the reports 300, 400, the module 140 uses data contained in the data storage module 110 to determine each prescriber's NPA group specialty. The module 140 does this by retrieving the ten digit prescriber number from the LRx market dynamics database 114. The module 140 indexes into the NPA database 118 using the ten digit prescriber code to access the prescriber's occupation code and primary specialty code. A different portion of the NPA database 118 is then accessed using the occupation code and primary specialty code to determine the NPA group specialty code. And finally, the module 140 indexes into still another portion of the NPA database 118 using the NPA group specialty code to access the NPA group specialty descriptions.

The product outlook report 300 contains a product group section 304 for each product group and an overall market total section 302. The information displayed in the overall market section 302, including the calculations of proportions, the calculations of confidence intervals and the rule determining censoring of data, is determined in the same manner as outlined below with respect to each product group except that product groups are ignored. Confidence levels allow users to gauge the reliability of the proportions.

The prescriber outlook report 400 contains sections for the top five specialties within the market as a whole and the NPA projected new and total prescription volume for each product group, the NPA projected total prescription volume for each product group and the market total. The rules for calculating and displaying information at the market level are the same as outlined below for each specialty except that product groups are ignored.

To generate the reports 300, 400, the proportions of valid values for the following LRx data attributes are calculated: LRx category: patient gender, patient age, and patient gender by age combination. The proportions are based on the number of individual LRx prescriptions with a given value of an attribute within the set of LRx prescription records with valid values for that attribute. The set of LRx records of the LRx market dynamics database 114 used for the calculation of proportions will be different for each attribute. Excluding an LRx record from the calculation of one attribute does not exclude it from being used for others.

Proportions will be calculated within each combination of attribute, product group, specialty, and week for the reports 300,400. These combinations are hereafter referred to as LRx attribute blocks.

These proportions will ultimately be converted to and displayed as percents having one decimal place. This is true for all LRx categories attributes except for LRx categories that will be converted to NPA prescription volume as described below. Even though percents will be displayed to only one decimal place, the proportions will held internally by the server 102 with at least six significant digits to prevent excessive rounding during confidence interval calculations and NPA prescription allocation.

When calculating the proportions of valid values for the LRx category attributes, the national prescription audit reporting module 140 will use LRx records that are both trackable and have a prescription type of new. The module 140 will not use LRx records that are non-trackable or represent refill prescriptions. While the module 140 is analyzing the data, if the module 140 reads an LRx record having a prescription type of add-on therapy, the prescription type is recoded to therapy switch to. The LRx category attribute is grouped in the following manner: new therapy start, switch to, continuation (new) and continuation (refill).

The prescription type continuation (refill) is displayed on the report as allocated NPA prescription counts, but the proportion of this group will not be calculated nor will confidence intervals be calculated for it's proportion. Instead, prescription counts for continuation (refill) will be calculated directly for the NPA data as described hereinbelow.

When calculating the patient gender attribute, the national prescription audit reporting module 140 will use LRx records with gender values denoting male and female. The module 140 will not use LRx records that do not have gender values denoting male or female.

When calculating the patient age attribute, the national prescription audit reporting module 140 will use LRx records that are trackable and non-trackable with a date of birth within the 110-year range ending with the census date for the current report. A missing month of birth does not invalidate the data of birth. The module 140 will not use LRx records that have an invalid or missing year of birth or have a date of birth outside the 110-year range ending with the census date for the current report. Patient age attributes may be grouped in the following manner: 0-18, 19-29, 30-55, 56-64, 65+.

During the calculation, records having missing month of births should be recoded to June if the year of birth is earlier than the dispensed year. Otherwise, the month of birth is recoded as January if a month is needed for calculations. If date functions are used which require a complete date, then the day of birth should be set to the 15th if the month-year of birth is earlier than the dispensed month-year. Otherwise, the day of birth is recoded as the 1st.

When calculating the patient gender by age attribute, the national prescription audit reporting module 140 will use all trackable and non-trackable LRx records with both a valid gender and date of birth as defined above. The module 140 will not use any records with an invalid gender or data of birth as defined above. Patient gender by age attributes may be grouped in the following manner: Female 0-18, Female 19-29, Female 30-55, Female 56-64, Female 65+, Male 0-18, Male 19-29, Male 30-55, Male 56-64, Male 65+.

The national prescription audit reporting module 140 censors data when there is insufficient confidence in the calculated proportions for an LRx characterization. The module 140 censors the data by not displaying the information in the reports 300, 400. A single period will be displayed in the place of the information/data. Individual data points, entire LRx attribute blocks, or all LRx attribute blocks within a product group by week or within a product group by specialty by week can be censored The module 140 determines what data is censored by checking the status of certain censor parameters. The censor parameters include NPA cutoff, CL cutoff, full censor and t fact.

NPA cutoff is a censor parameter. NPA cutoff is generally an integer value describing the total prescription volume below which LRx attribute blocks will not be shown. If the total prescription volume is too low, all attribute blocks within a week within a product group are censored if for a particular week the NPA projected total prescription volume is below NPA cutoff, then all calculated percentages and counts will be censored for all LRx attribute blocks for that week.

CL cutoff is a censor parameter. CL cutoff is generally an integer value describing the confidence interval value above which a single calculated percent or count will not be shown. A single data point within attribute blocks can be censored. If the calculated confidence interval for a particular calculated percent is above CL cutoff, that single data value will be censored. If CL cutoff is set to zero, no censoring based on confidence intervals is to be performed.

Full censor is a censor parameter which is set to either YES or NO. Full censor is a flag indicating whether an entire attribute block is to be censored as a unit due to confidence interval cutoff censoring. Setting full censor to YES causes a single attribute block within a week within a product group to be censored. If full censor is set to ‘YES’, and if one or more data points within an LRx attribute block is censored due to the confidence interval cutoff, then all data points within that block will be censored.

T fact is a censor parameter which is a floating point number. In a preferred embodiment, the t fact parameter is precise up to a thousandth of a unit. The value of the t fact parameter is used in calculating the confidence interval around a proportion.

For each calculated LRx proportion, confidence intervals will be calculated. Confidence levels describe the reliability of the proportions and allow users to gauge the same.

At step 502, the server 102 determines whether the NPA projected prescription volume for a product group, week combination, or product group, specialty, week combination (“N”) is less than two. If so, the process advances to step 508 and the server 102 sets the calculated confidence interval equal to zero. Otherwise, the process 500 advances to step 504. At step 504, the server 102 determines whether the total LRx prescription count of records used in calculating LRx attribute proportions (“n”) is equal to zero or greater than or equal to N. If so, the process advances to step 508 and the server 102 sets the calculated confidence interval equal to zero. Otherwise, the process 500 advances to step 506. The attribute proportions calculated are the proportions for the LRx category attribute, the patient gender attribute, the patient age attribute, and the patient gender by age attribute.

At step 506, the server 102 calculates the calculated confidence interval. The calculated confidence interval is computed according to the equation (1):
CI=T_{—}FACT*sqrt{[(N−n)*p*(1−p)]/[(N−1)*n]}, (1)
where CI is the confidence interval, T_FACT is the censor parameter t fact, N is the NPA projected prescription volume for a product group, week combination, or product group, specialty, week combination, n is the total LRx prescription count of records used in calculating LRx attribute proportions, and p is the calculated proportion. Once the calculated confidence interval is computed, the process 500 exits.

Unlike the other attributes, LRx categories will not be displayed as percents. Instead, LRx Category prescription counts are to be calculated by allocating the NPA projected volume using the calculated proportions. Each count is rounded to a whole number once it is calculated so that when calculated in the order given, the categories will sum up to match the NPA volume. The proportion of new therapy starts equals NPA new prescriptions over the new therapy starts. The proportion of switch to equals NPA new prescriptions over the switch to. The number of continuation (new) is calculated by subtracting new therapy starts and switch to from NPA new prescriptions. And the number of continuation (refill) is calculated by subtracting NPA new prescriptions from NPA total prescriptions.

For the specialty report only top five specialties within each product group will be displayed. Prescriber specialty groups will be based on the NPA specially grouping. Specialty rankings will be based on NPA projected total prescription volume for the most recent data week in the report.

The final product of the national prescription audit reporting module 140 is two comma delimited files which when loaded into a spreadsheet will be in the final deliverable form except for minor formatting and row grouping, which may be accomplished by simple macros and/or software programs as well as through other processes.

Within each product group or product group by specialty grouping, the following information will be displayed: group heading/product group name specialty description 402, NPA new and total projected prescription volume 404, NPA projected prescription volume allocated into LRx categories based on the observed distribution of LRx categories 406, LRx patient demographic attributes displayed as a percent of LRx prescriptions: LRx Gender 408, LRx Age 410, LRx Gender by Age 412.

A row should be created for each valid value of each LRx attribute even if no LRx prescription with that value is present. In those cases, the value's calculated proportion and confidence interval will be set to or considered zero and percents or counts are to be reported as zero. The standard rules for censoring data apply to these no data cases.

Each row of out put is to be identified with a row type indicator, which is to be the first value in each row. The value of the row type indicator identifies the type of information contained in a row. This field can be used for automatic formatting and row grouping of spreadsheets. This field may be either stripped out or hidden in the final deliverable.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

What is claimed is:

1. A method for analyzing prescription data, comprising the steps of:
receiving an indication of a selected report type;
accessing at least one from the group consisting of product oriented longitudinal data, patient oriented longitudinal data and prescriber oriented longitudinal data based at least in part on the selected report type;
analyzing the accessed at least one from the group consisting of product oriented longitudinal data, patient oriented longitudinal data and prescriber oriented longitudinal data; and
formatting a report of the selected report type including the accessed at least one from the group consisting of product oriented longitudinal data, patient oriented longitudinal data and prescriber oriented longitudinal data.

2. The method of claim 1 wherein the selected report type is a product oriented report.

3. The method of claim 1 wherein the selected report type is a patient oriented report.

4. The method of claim 1 wherein the selected report type is a prescriber oriented report.

5. The method of claim 1, wherein the longitudinal data covers a range of time of at least twelve months in duration.

6. The method of claim 1, wherein the longitudinal data covers a range of time of at most six years.

7. The method of claim 1, wherein the report includes proportions of valid values for a data attribute.

8. The method of claim 7, wherein the data attribute includes at least one from a group consisting of category, patient gender, patient age, and patient gender by age combination.

9. The method of claim 7, wherein each of the proportions is associated with a confidence interval, wherein the confidence interval describes the reliability of the proportion.

10. A system for accessing sales data, comprising:
a data storage device including a database and configured to receive a data access request indicating a selected report type, accesses at least one of product oriented longitudinal data, patient oriented longitudinal data and prescriber oriented longitudinal data based at least in part on the selected report type, and transmit data responsive to the data access request; and
a server coupled to said data storage device and configured to receive an indication of a selected report type, send a data access request to the data storage device, receive the at least one of product oriented longitudinal data, patient oriented longitudinal data and prescriber oriented longitudinal data from the data storage device, analyze the at least one of product oriented longitudinal data, patient oriented longitudinal data and prescriber oriented longitudinal data, and format a report of the selected report type including the at least one of product oriented longitudinal data, patient oriented longitudinal data and prescriber oriented longitudinal data.

11. The system of claim 10, wherein the longitudinal data covers a range of time of at least twelve months in duration.

12. The system of claim 10, wherein the longitudinal data covers a range of time of at most six years.

13. The system of claim 10, wherein the report includes proportions of valid values for a data attribute.

14. The system of claim 13, wherein the data attribute includes at least one of category, patient gender, patient age, and patient gender by age combination.

15. The system of claim 13, wherein each of the proportions is associated with a confidence interval, wherein the confidence interval describes the reliability of the proportion.

16. A logic arrangement for accessing data, wherein the logic arrangement is adapted for an execution by a processing arrangement to perform the steps comprising of:
receiving an indication of a selected report type;
accessing at least one of product oriented longitudinal data, patient oriented longitudinal data and prescriber oriented longitudinal data based at least in part on the selected report type;
analyzing the at least one of product oriented longitudinal data, patient oriented longitudinal data and prescriber oriented longitudinal data; and
formatting a report of the selected report type including the at least one of product oriented longitudinal data, patient oriented longitudinal data and prescriber oriented longitudinal data.

17. The logic arrangement of claim 16, wherein the longitudinal data covers a range of time of at least twelve months in duration.

18. The logic arrangement of claim 16, wherein the longitudinal data covers a range of time of at most six years.

19. The logic arrangement of claim 16, wherein the report includes proportions of valid values for a data attribute.

20. The logic arrangement of claim 19, wherein the data attribute includes at least one of category, patient gender, patient age, and patient gender by age combination.

21. The logic arrangement of claim 19, wherein each of the proportions is associated with a confidence interval, wherein the confidence interval describes the reliability of the proportion.
